(19) United States
(12) Patent Application Publication
(10) Pub. No.: US 2007/0220618 A1
(43) Pub. Date: Sep. 20, 2007

(54) System and method for power over ethernet signaling

(76) Inventors: Bruce Holmes, Austin, TX (US); Joseph David DeNiro, Austin, TX (US); Joseph Farrell, Austin, TX (US); Robert Luis, Round Rock, TX (US); Mohana R. Mullapudi, Austin, TX (US); Cuong T. Nguyen, Austin, TX (US); Liam B. Quinn, Austin, TX (US); Robert Winter, Leander, TX (US)

Correspondence Address: HAMILTON & TERRILE, LLP, P.O. BOX 203518, AUSTIN, TX, 78720, US

(21) Appl. No.: 11/384,875

(22) Filed: Mar. 20, 2006

(51) Int. Cl. G06F 11/00

(52) U.S. Cl. 726/36

(57) ABSTRACT

Network communication cables that provide power, such as Ethernet cables in compliance with the Power over Ethernet standard, are secured so that unauthorized devices are restricted from receiving power. After a PoE connection is established between a powered device (PD) and power source equipment (PSE) over an Ethernet cable, the PD communicates security information to the PSE with low frequency variations in the current drawn by the PD through the Ethernet cable. The PSE terminates power to the PD if the PD fails to communicate the security information in a predetermined time period or if the security information fails to match authorized security information. Alternatively, the PSE generates an unauthorized device message for presentation at the network if the security information fails to match the authorized security information.

### BACKGROUND OF THE INVENTION

1. Field of the Invention

The present invention relates in general to the field of providing power over a network connection, and more particularly to a system and method for power over Ethernet signaling.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems and peripherals deployed in businesses and even homes typically interface with one or more networks. Conventional local area networks (LANs) typically use CAT 5 UTP Ethernet cabling to communicate information between information handling systems and peripherals. Generally, these cables are routed throughout a building from one or more centralized locations where switches and server information handling systems coordinate communication of information over the network. Often, the local area network supports wireless communication by deploying wireless access points around the network building space. Information handling systems communicate with the network through wireless signals supported by the access points, such as in compliance with the 802.11 (a), (b) and (g) standards. However, the wireless access points typically still use Ethernet cabling to communicate with the centralized switches and servers of the local area network. In addition, the wireless access points generally have power adapters and cabling to support their operation.

In order to provide greater flexibility in the placement and use of network devices, the IEEE developed the 802.3af standard that defines support for providing power to devices through CAT 5 UTP cabling. The Power-over-Ethernet (PoE) standard drives DC power over the Ethernet cable to eliminate the requirement for AC power installation at remote devices and appliances. For example, a wireless access point powered through its Ethernet cable may be placed where desired for best transmission and reception rather than for proximity to a power outlet. Other devices that may receive power over Ethernet cabling include VoIP phones, portable information handling systems, cameras, MP3 players, cell phones and PDA devices. Although installation of PoE capability enhances an enterprise IT environment by allowing greater freedom in the placement of network devices, an overhead cost is associated with installation of PoE source equipment (PSE) to support PoE. For instance, a business enterprise that installs a low cost version of PSE for an anticipated draw of power by PoE devices may have to upgrade the PSE if the power drawn by devices exceeds the anticipated power draw. Over use of PSE capability may occur if unauthorized devices interface with PoE jacks, such as personal rather than business enterprises devices, like MP3 players, personal cameras or personal portable information handling systems.

### SUMMARY OF THE INVENTION

Therefore a need has arisen for a system and method which secures PoE capability from unauthorized use.

In accordance with the present invention, a system and method are provided which substantially reduce the disadvantages and problems associated with previous methods and systems for securing PoE capability from unauthorized use. A powered device interfaced with a network communication cable to receive power sends security information through the network communication cable to verify that the powered device is authorized to receive power. Failure to provide security information in a predetermined time results in a predetermined action by power source equipment that provides the power, such as termination of power to the powered device or generation of an unauthorized device message.

More specifically, a network communicates information between a network location and one or more devices, such as information handling systems, through Ethernet cables. The network location has power source equipment (PSE), such as a switch, that provides power through the Ethernet cable to powered devices (PD), such as compliant with the IEEE 802.3af Power over Ethernet (PoE) standard. Upon initiation of power to a powered device, a device security module associated with the powered device communicates security information through the Ethernet cable to the PSE by using low frequency variations in the current drawn by the powered device. A network security module associated with the PSE receives the security information and continues power to the powered device if the powered device is authorized to receive power. If the network security device does not receive valid security information in a predetermine time period after initiation of power, the network security device performs a security action, such as termination of power to the device or generation of an unauthorized device message for presentation at a network management interface.

The present invention provides a number of important technical advantages. One example of an important technical advantage is that access to PoE capability for a network is restricted to authorized devices. Preventing unauthorized devices from accessing a PoE capability reduces demand placed on PSE that provides PoE and makes the demand more predictable for selection of PSE in a network environment. Signaling by devices to obtain power has minimal impact on device performance and does not impact device interaction with non-secure PoE interfaces. Devices are enabled for interaction with a secure network with a code for that network enabled by software or firmware instructions and without hardware changes. Code security is maintained since measurement of current on a PoE network is not typically accessible by a device end user.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a network having secured PoE capability; and

FIG. 2 depicts a flow diagram of a process for securing PoE access by powered devices interfaced with power source equipment through an Ethernet cable.

### DETAILED DESCRIPTION

Securing access to Power over Ethernet capability prevents unauthorized information handling systems or other powered devices to draw power from power source equipment. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

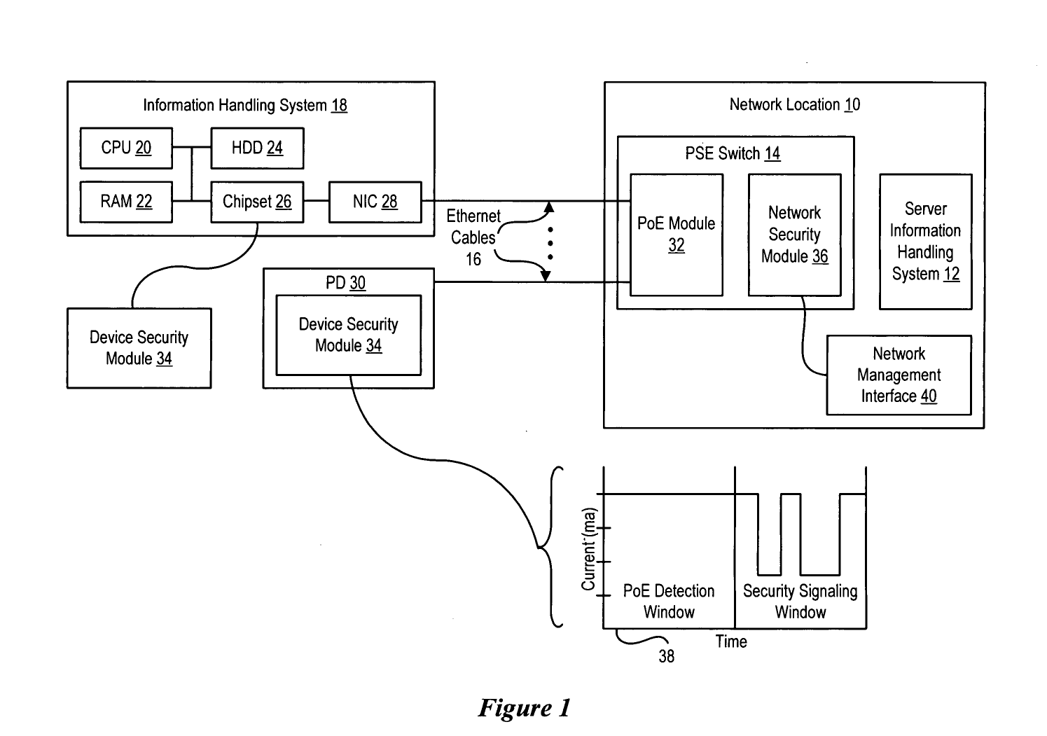

Referring now to FIG. 1, a block diagram depicts a network having secured PoE capability. A network location 10 includes an information handling system server 12 that manages communication of information across the network and a PSE switch 14 that coordinates access to server information handling system 12 by information received through plural Ethernet cables 16. For instance, an information handling system 18 having plural processing components, such as a CPU 20, RAM 22, hard disk drive 24, chipset 26 and network interface card 28, communicates over an Ethernet cable 16 through PSE switch 14 and with server information handling system 12. Other types of powered devices 30 also communicate through Ethernet cables 16, such as Voice over Internet Protocol (VoIP) phones, wireless access points, cameras, PDAs, MP3 players and cell phones.

Upon initial connection of an information handling system 18 or other type of powered device 30 with an Ethernet cable 16, a PoE module 32 determines whether the device accepts power over Ethernet in accordance with the PoE standard and, if so, applies power to the Ethernet cable 16. Upon receiving power through Ethernet cable 16, a device security module 34 associated with the device generates security information for communication to PSE switch 14 through the Ethernet cable 16. For instance, device security module 34 is firmware instructions residing in the chipset 26 or NIC 28 of information handling system 18 or in appropriate locations of other types of powered devices 30. The security information is communicated through Ethernet cable 16 to PoE module 32 and read by a network security module 36. Network security module 36 compares the received security information with expected security information to determine if the powered device sending the security information is authorized to access power from PoE module 32. For instance, the security information is a predetermined security code, device type information, manufacturer information, or other desired device parameters.

Device security module 34 sends security information as low frequency variations in the current drawn by the device, as is depicted by graph 38. Device security module 36 allows a PoE detection window to pass so that a normal PoE interface is established and then sends the security information during a security signaling window, such as by sequences of reduced power draws over time or reduced power draws to specified current levels over time. Network security module 36 monitors the power drawn through Ethernet cable 16 for a predetermined time period after the PoE interface is established to detect security information sent from device security module 34. If the security information is not received by network security module 36 in the predetermined time, the powered device is determined as not authorized to receive power and network security module 36 takes appropriate action. For instance, power is automatically terminated to unauthorized devices or an unauthorized device message is generated for presentation at a network management interface 40 to allow a network manager to locate and disconnect the unauthorized device. If security information is received by network security module 36 in the predetermined time, the information is compared with expected information so that a match allows continuation of power while a failure to match allows termination of power or presentation of an unauthorized device message.

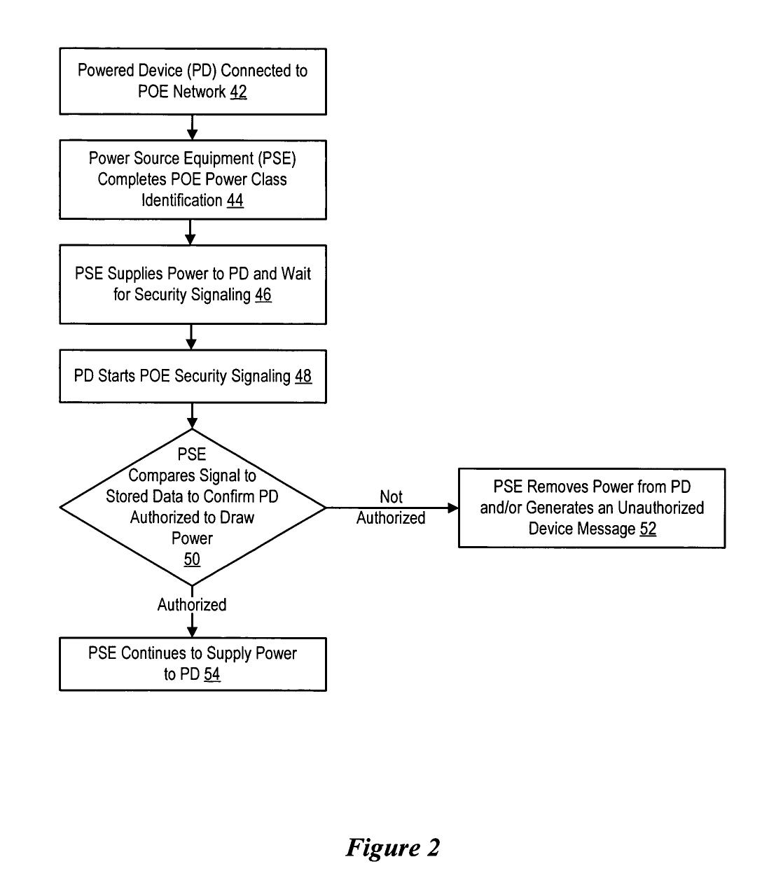

Referring now to FIG. 2, a flow diagram of a process for securing PoE access by powered devices interfaced with power source equipment through an Ethernet cable. The process begins at step 42 with connection of the powered device to the Power over Ethernet network. At step 44, the power source equipment of the PoE network completes the power class identification of the powered device in accordance with the PoE standard and, at step 46, supplies power to the powered device to support security signaling by the powered device. At step 48, the powered device initiates security signaling by varying the power drawn through the network in a predetermined sequence. At step 50, the power source equipment compares the security signaling to stored security data to verify authorization of the powered device to draw power. If the security signals fail to match stored security data, the process continues to step 52 for the power source equipment to remove power from the device. If the power source equipment verifies that the powered device is authorized to draw power, the process continues to step 54 to allow continued supply of power to the device.

Although the present invention has been described in detail, it should be understood that various changes, substitutions and alterations can be made hereto without departing from the spirit and scope of the invention as defined by the appended claims.

What is claimed is:

1. A system for securing power transfer from a network location over a network communication cable to a device, the system comprising:
a device security module operable to communicate security information through the network communication cable by varying current draw at the device from the cable; and
a network security module operable to receive the security information from the device security module through the network communication cable by detecting the varying current draw, to verify authorization of the device to receive power, and to perform a predetermined action if the device lacks authorization to receive power.

2. The system of claim 1 wherein the network communication cable comprises an Ethernet cable.

3. The system of claim 2 wherein the security information comprises a code associated with access to the network location.

4. The system of claim 2 wherein the security information comprises the device type.

5. The system of claim 2 wherein the security information comprises the device manufacturer.

6. The system of claim 1 wherein the network security module is further operable to set a predetermined time window at detection of a device and wherein the predetermined action comprises termination of power to the device if the device fails to communicate security information in the predetermined time window.

7. The system of claim 1 wherein the network security module is further operable to set a predetermined time window at detection of a device and wherein the predetermined action comprises generation of an unauthorized device message if the device fails to communicate security information in the predetermined time window.

8. A method for securing power transfer from a network location through a network communication cable to a device, the method comprising:
connecting the device to the network communication cable;
providing power from the network location through the network communication cable to the device;
varying current drawn by the device from the network communication cable in a predetermined pattern;
detecting the predetermined pattern at the network location;
continuing power from the network location if the predetermined pattern matches a security pattern; and
terminating the power from the network location if the predetermined pattern fails to match the security pattern.

9. The method of claim 8 further comprising:
generating an unauthorized device message if the predetermined pattern fails to match the security pattern; and
presenting the unauthorized device message at a network management location.

10. The method of claim 8 wherein terminating the power further comprises:
initiating a predetermined time window upon the providing of power from the network location; and
terminating the power if the predetermined pattern is not detected in the predetermined time window.

11. The method of claim 8 wherein the network communication cable comprises an Ethernet cable.

12. The method of claim 8 wherein the network location comprises a switch having Power over Ethernet.

13. The method of claim 8 wherein the device comprises a VoIP phone.

14. The method of claim 8 wherein the devices comprises an information handling system.

15. The method of claim 8 wherein the security pattern comprises a security code.

16. A method for securing power transfers through a network communication cable, the method comprising:
detecting connection of a device to the network communication cable;
providing power to the device through the network communication cable;
monitoring the power provided to the device for a predetermined pattern; and
terminating the power provided to the device if the predetermined pattern is not detected for a predetermined time.

17. The method of claim 16 further comprising:
detecting the predetermined pattern; and
terminating the power if the predetermined pattern fails to match a security pattern.

18. The method of claim 16 further comprising:
generating an unauthorized device message if the predetermined pattern is not detected for the predetermined time; and
presenting the unauthorized device message at a network management interface.

19. The method of claim 16 wherein the network communication cable comprises an Ethernet cable.

20. The method of claim 16 wherein the predetermined pattern comprises variations in the current drawn by the device.
